(19) United States
(12) Patent Application Publication
(10) Pub. No.: US 2025/0146539 A1
(43) Pub. Date: May 8, 2025

(54) OVERLOAD PROTECTING DEVICE

(71) Applicant: TSUBAKIMOTO CHAIN CO., Osaka-shi (JP)

(72) Inventors: Fumiya Murase, Osaka-shi (JP); Ryota Mase, Osaka-shi (JP)

(73) Assignee: TSUBAKIMOTO CHAIN CO., Osaka-shi (JP)

(21) Appl. No.: 18/928,320

(22) Filed: Oct. 28, 2024

(30) Foreign Application Priority Data
Nov. 7, 2023 (JP) 2023-189924

(51) Int. Cl. F16D 7/02

(52) U.S. Cl. CPC F16D 7/021; F16D 2200/0056

(57) ABSTRACT

To provide an overload protecting device with a simple structure and a low machining cost, capable of increasing a transmission torque, improving accuracy of an allowable torque to be set, and capable of continuous use even after an overload state, once it returns to a normal torque. A torque transmission mechanism for torque transmission, cam sliding surfaces 111, 121 of an inner ring 120 and an outer ring 110have cylindrical shapes, the torque transmission mechanism has a plurality of cams 130 provided in a circumferential direction between the cam sliding surfaces 111, 121 and urging means 140 for urging the plurality of cams 130 in a rotating direction thereof, and the cam 130 has a plurality of minimum radius parts and a plurality of maximum radius parts disposed alternately and formed having a rotationally symmetric shape to a rotation center thereof.

### BACKGROUND OF THE INVENTION

### 1. Field of the Invention

The present invention relates to an overload protecting device which includes an inner ring and an outer ring provided capable of relative rotation on the same axis and a torque transmission mechanism for transmitting torques of the inner ring and the outer ring and can shut down the transmission of a torque equal to or larger than an allowable level.

### 2. Description of the Related Art

An overload protecting device which includes a torque transmission mechanism for transmitting a torque between two shafts and can shut down transmission of a torque equal to or larger than an allowable level is well-known.

For example, as in Japanese Patent No. 7006664, an overload protecting device which includes a torque transmission mechanism for transmitting a torque between an inner ring and an outer ring provided capable of relative rotation on the same axis and is capable of shutting down the transmission of a torque equal to or larger than an allowable level is publicly known.

The overload protecting device described in Japanese Patent No. 7006664 is constituted such that a plurality of engagement portions (221) presenting a recessed arc shape are provided on an inner peripheral surface of an outer ring (second main body 20), a torque is transmitted by pressing the engagement portions (221) so as to urge a drive member (30) from an inner ring (first main body 10) to an outer peripheral side, and a torque equal to or larger than an allowable level is shut down by movement of the drive member (30) to the inner ring side against the urging force.

### SUMMARY OF THE INVENTION

The overload protecting device described in Japanese Patent No. 7006664 is constituted by a torque transmission mechanism between an inner ring and an outer ring and is capable of size reduction, but shapes of both the inner ring and the outer ring become complicated, and machining costs are raised, which was a problem.

Moreover, the number of torque transmission spots on a circumference is one, and since the torque transmission spots in the number larger than that of the engagement portions (221) at the maximum cannot be provided, it was difficult to increase the transmission torque.

Furthermore, a pressing force of an elastic member which urges the drive member (30) is also restricted, and the transmission torque cannot be increased easily, and since the elastic member gives a large pressing pressure with a short stroke in a small space, there was such a problem that it was difficult to raise accuracy of an allowable torque to be set.

In order to obtain a large transmission torque, a limit of an allowable torque of a one-way clutch by a general cam can be used as an overload protecting device.

However, if the cam clutch exceeds the limit of the allowable torque, it remains in a state where the torque transmission is shut down, and it is impossible to return to the torque transmission state again and thus, though it can be used as an overload protecting device at emergency, it cannot be applied to such a use that continuous use is available even after the overload state, once returning to the normal torque, which was a problem.

The present invention solves these problems and has an object to provide an overload protecting device with a simple structure, a low machining cost, an increased transmission torque, and higher accuracy of an allowable torque to be set and which can be continuously used even after the overload state, once it returns to a normal torque.

The present invention is an overload protecting device including an inner ring and an outer ring provided capable of relative rotation on the same axis and a torque transmission mechanism performing torque transmission of the inner ring and the outer ring, which can shut down the torque transmission to a torque equal to or larger than an allowable level, in which an outer peripheral surface of the inner ring and an inner peripheral surface of the outer ring have cylindrical shapes, the torque transmission mechanism has a plurality of cams provided in a circumferential direction between the outer peripheral surface of the inner ring and the inner peripheral surface of the outer ring and urging means for urging the plurality of cams to a rotating direction thereof, the cam has a plurality of minimum radius parts and a plurality of maximum radius parts disposed alternately and is formed having a rotationally symmetric shape with respect to a rotation center, in a state where the minimum radius part is opposed to the inner peripheral surface of the outer ring, a diameter including the minimum radius part is formed smaller than an interval between the outer peripheral surface of the inner ring and the inner peripheral surface of the outer ring, and in a state where the maximum radius part is opposed to the inner peripheral surface of the outer ring, the diameter including the maximum radius part is formed larger than the interval between the outer peripheral surface of the inner ring and the inner peripheral surface of the outer ring, whereby the aforementioned problem is solved.

According to the invention according to claim 1, since the outer peripheral surface of the inner ring and the inner peripheral surface of the outer ring have cylindrical shapes, the cam has a plurality of the minimum radius parts and a plurality of the maximum radius parts disposed alternately and is formed having a rotationally symmetric shape with respect to the rotation center thereof, a structure is simple and a machining cost is low, and continuous use is made possible even after an overload state, once returning to a normal torque.

Moreover, a large number of the cams can be disposed in a circumferential direction, and a torque is transmitted when the cam rotates and bites into a gap between the outer peripheral surface of the inner ring and the inner peripheral surface of the outer ring by slight elastic deformation of the outer peripheral surface of the inner ring and the inner peripheral surface of the outer ring and thus, a large torque can be transmitted.

According to a configuration described in claim 2, since a minimum diameter connecting the minimum radius parts at two spots and a maximum diameter connecting the maximum radius parts at two spots are disposed so as to form an angle other than 90°, the use as a one-way clutch that transmits a torque only in one direction is made possible.

According to a configuration described in claim 3, urging means has a spring that is extended around a pressing portion provided in the cam and urges the pressing portion in an inner-ring direction, the pressing portion provided in the cam is formed so as to be pressed by the spring at a position eccentric with respect to a rotation center of the cam, and in a state where the minimum radius part is opposed to the inner peripheral surface of the outer ring, the diameter including the minimum radius part is formed smaller than an interval between the outer peripheral surface of the inner ring and the inner peripheral surface of the outer ring and thus, an operation as a one-way clutch at rotation in a direction opposite to the overload protection is made possible.

According to a configuration described in claims 4 and 5, a biting amount by the rotation of the cam can be increased with respect to the torque to be transmitted, and an allowable torque can be accurately set with a small torque.

### BRIEF DESCRIPTION OF THE DRAWINGS

FIG. 1 is a side view of an overload protecting device according to an embodiment of the present invention;

FIG. 2 is an explanatory diagram of a state where a transmission torque is zero;

FIG. 3 is an explanatory diagram of a state where the transmission torque is maximum;

FIG. 4 is a graph illustrating a relation among a rotation angle and a deflection amount of a cam and a transmission torque; and

FIGS. 5A to 5E are schematic diagrams of an overload protecting device according to another embodiment.

### DESCRIPTION OF THE PREFERRED EMBODIMENTS

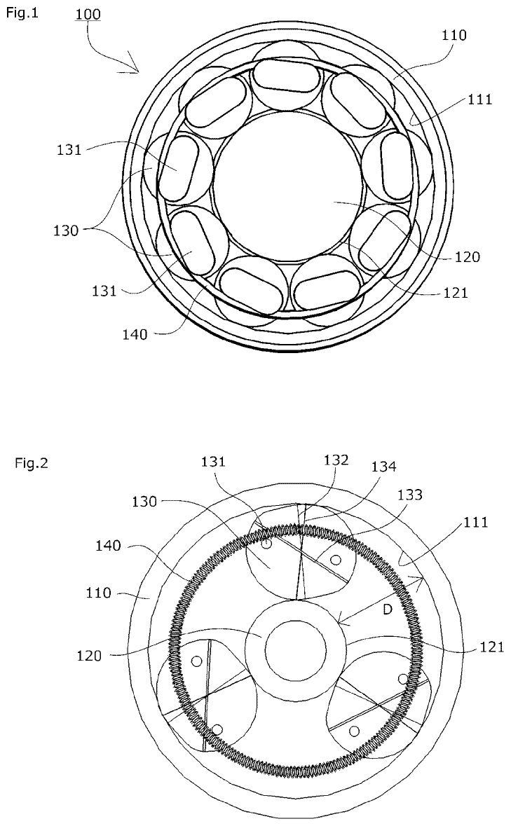

An embodiment of the present invention will be explained with reference to FIGS. 1 to 3. However, the present invention is not limited to these embodiments.

### EMBODIMENT

An overload protecting device 100 according to an embodiment of the present invention includes, as shown in FIG. 1, an inner ring 120 and an outer ring 110 provided capable of relative rotation on the same axis and a torque transmission mechanism for performing torque transmission of the inner ring 120 and the outer ring 110.

An outer peripheral surface of the inner ring 120 and an inner peripheral surface of the outer ring 110 have cylindrical shapes, respectively, have a plurality of cams 130 provided in a circumferential direction between the outer peripheral surface of the inner ring 120 and the inner peripheral surface of the outer ring 110 and a spring 140, which is urging means for urging the plurality of cams 130 in a rotation direction thereof, which constitute the torque transmission mechanism with the outer peripheral surface of the inner ring 120 and the inner peripheral surface of the outer ring 110 as cam sliding surfaces 121, 111, respectively.

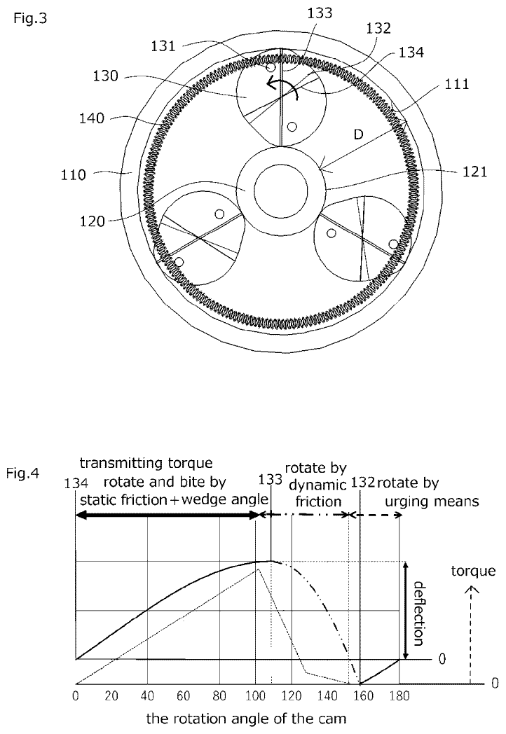

The cam 130 has, as shown in FIGS. 2 and 3, two minimum radius parts and two maximum radius parts disposed alternately and is formed having a rotationally symmetric shape with respect to a rotation center thereof, a diameter including the two minimum radius parts constitutes a minimum diameter 132, and a diameter including the two maximum radius parts constitute a maximum diameter 133.

Moreover, the minimum diameter 132 is formed smaller than an interval D between a cam sliding surface 121 of the inner ring 120 and a cam sliding surface 111 of the outer ring 110, and the maximum diameter 133 is formed larger than the interval D between the cam sliding surface 121 of the inner ring 120 and the cam sliding surface 111 of the outer ring 110.

Note that FIGS. 2 and 3 depict the size and the shape of the cam emphatically than the actual one for explanation.

The cam 130 has a contact diameter 134 with the same dimension as that of the interval D between the cam sliding surface 121 of the inner ring 120 and the cam sliding surface 111 of the outer ring 110, is urged so as to rotate by the spring 140 extended around a pressing portion 131 and is brought into a state where a part of the contact diameter 134 is brought into contact with both the cam sliding surface 121 of the inner ring 120 and the cam sliding surface 111 of the outer ring 110, relative rotation of the inner ring 120 and the outer ring 110 in one direction (the outer ring 110 in an illustrated clockwise direction) is allowed, and transmission of a rotation torque is shut down, while in the relative rotation of the inner ring 120 and the outer ring 110 in the other direction (the outer ring 110 in an illustrated counterclockwise direction), the cam 130 rotates in an arrow direction in FIG. 3 and bites into a gap between the cam sliding surfaces 111, 121 of the inner ring 120 and the outer ring 110 in a wedge shape, whereby the relative rotation is hindered, and the rotation torque is transmitted.

An operation of the overload protecting device 100 constituted as above will be explained on the basis of FIGS. 2 to 4.

A state where a part of the contact diameter 134 of the cam 130 shown in FIG. 2 is in contact with both the cam sliding surface 121 of the inner ring 120 and the cam sliding surface 111 of the outer ring 110 is assumed to be a rotation angle 0° of the cam 130.

As shown in FIG. 4, the contact diameter 134 has the same dimension as that of the interval D between the cam sliding surface 121 of the inner ring 120 and the cam sliding surface 111 of the outer ring 110, and in the 0° state, expansion (expressed as “deflection” in the illustration) of the interval D by the slight elastic deformation of the inner ring 120 and the outer ring 110 does not occur, and the transmittable torque is also zero.

If the outer ring 110 is to relatively rotate with respect to the inner ring 120 in the illustrated counterclockwise direction from this state, the cam 130 rotates while biting in accordance with an increase in the torque to be transmitted, and the deflection also increases.

In this section, the transmittable torque is the sum of a force (force by a wedge angle) in a tangent direction generated when a point of action of a force of the cam 130 and the cam sliding surface 121 of the inner ring 120 and a point of action of the force of the cam 130 and the cam sliding surface 111 of the outer ring 110 shift in angles in the circumferential direction due to the shape of the cam 130 and a force generated by static friction between the cam 130 and the inner ring 120, the cam sliding surface 111 of the outer ring 110.

Therefore, deflection becomes the maximum at an angle (approximately 110° in the illustrated embodiment) at which the maximum diameter 133 of the cam 130 shown in FIG. 3 perpendicularly intersects the cam sliding surface 121 of the inner ring 120 and the cam sliding surface 111 of the outer ring 110, and a force by static friction becomes the maximum, but since the force by the wedge angle becomes the maximum slightly before that, the rotation angle of the cam 130, which becomes the maximum allowable torque, is slightly before the rotation angle at which the deflection becomes the maximum (approximately 100° in the illustrated embodiment).

When the maximum allowable torque is exceeded, slippery occurs between the cam 130 and the cam sliding surface 121 of the inner ring 120 or the cam sliding surface 111 of the outer ring 110, the inner ring 120 and the outer ring 110 start relative rotation, and the transmission torque rapidly lowers and thus, damage or a bad influence by the overload is prevented.

Even after the maximum allowable torque is exceeded, the deflection remains even while decreasing to an angle (approximately 150° in the illustrated embodiment) at which the minimum diameter 132 of the cam 130 perpendicularly intersects the cam sliding surface 121 of the inner ring 120 and the cam sliding surface 111 of the outer ring 110 and thus, the cam 130 further rotates by dynamic friction.

At a position where the deflection becomes zero and after, the transmission torque becomes zero, but since the cam 130 is urged by the spring 140 so as to rotate, the cam 130 rotates further 180°, that is, to 0° shown in FIG. 2, and the torque transmission is started again.

In this embodiment, the interval D is expanded by slight elastic deformation of the inner ring 120 and the outer ring 110 by biting of the cam 130, but the interval D may be expanded by assembling an elastic member in the inner ring and the outer ring.

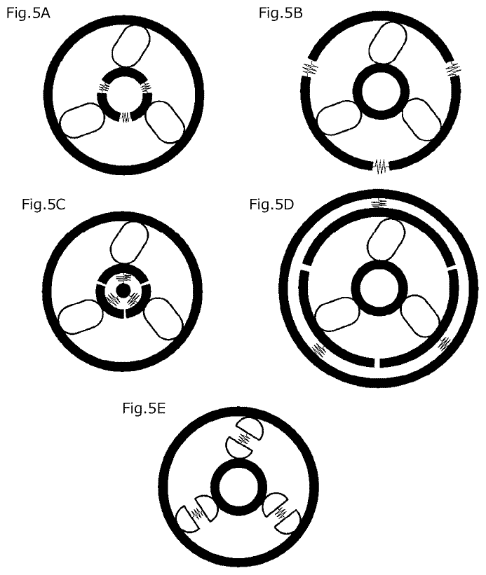

For example, as schematically illustrated in FIGS. 5A to 5E, there may be such cases that the cam sliding surface of the inner ring is divided into a plurality of parts in the circumferential direction, and the elastic member is disposed in the circumferential direction between the respective divided surfaces (a); the cam sliding surface of the outer ring is divided into a plurality of parts in the circumferential direction, and the elastic member is disposed in the circumferential direction between the respective divided surfaces (b); the cam sliding surface of the inner ring is divided into a plurality of parts in the circumferential direction, and the elastic member pressing each of them in a radial direction is disposed (c); the cam sliding surface of the outer ring is divided into a plurality of parts in the circumferential direction, and the elastic member pressing each of them in a radial direction is disposed; and the like.

Moreover, as shown in FIG. 5E, the elastic member may be assembled in the cam itself such that the biting is generated by deformation of the cam itself.

As above, the embodiment of the present invention has been described in detail, but the present invention is not limited to the above-described embodiment but is capable of various design changes without departing from the present invention described in the scope of claims.

In the above-described embodiment, the cam 130 has a shape that is twice (180°) rotationally symmetric but may be even-number rotational symmetry of four-times (90°) rotational symmetry or more or the like.

In the above-described embodiment, it acts as a one-way clutch in which the torque transmission direction is only rotation in one direction and the rotation in the opposite direction is free, but by mixing a cam disposed so as to act on the rotation in the opposite direction, it may be configured capable of torque transmission in the both directions and of overload protection.

Moreover, in the above-described embodiment, in a state where the minimum radius part is opposed to the inner peripheral surface of the outer ring, the diameter including the minimum radius part is formed smaller than the interval between the outer peripheral surface of the inner ring and the inner peripheral surface of the outer ring so as to configure that the overload protection is available for the relative rotation in one direction, while the relative rotation in the other direction is free, but if the relative rotation in the other direction is not considered, the urging means may be omitted by configuring such that the cam remains in a state in contact with the outer peripheral surface of the inner ring and the inner peripheral surface of the outer ring with the diameter including the minimum radius part as the interval between the outer peripheral surface of the inner ring and the inner peripheral surface of the outer ring all the time.

Furthermore, the overload protection may be made possible for the relative rotation in the both directions by forming the cam shape such that the force by the wedge angle is generated in the both directions.

What is claimed is:

1. An overload protecting device comprising an inner ring and an outer ring provided capable of relative rotation on the same axis and a torque transmission mechanism for transmitting torques of the inner ring and the outer ring and capable of shutting down the transmission of a torque equal to or larger than an allowable level, wherein
an outer peripheral surface of the inner ring and an inner peripheral surface of the outer ring have cylindrical shapes;
the torque transmission mechanism has a plurality of cams provided in a circumferential direction between the outer peripheral surface of the inner ring and the inner peripheral surface of the outer ring;
a plurality of minimum radius parts and a plurality of maximum radius parts are alternately disposed, and the cam is formed with a rotationally symmetric shape with respect to a rotation center thereof; and
in a state where the maximum radius part is opposed to the inner peripheral surface of the outer ring, a diameter including the maximum radius part is formed larger than an interval between the outer peripheral surface of the inner ring and the inner peripheral surface of the outer ring.

2. The overload protecting device according to claim 1, wherein
the cam has the minimum radius parts at two spots at a position of 180° and the maximum radius parts at two spots at a position of 180°; and
a minimum diameter connecting the minimum radius parts at the two spots and a maximum diameter connecting the maximum radius parts at the two spots are disposed so as to form an angle other than 90°.

3. The overload protecting device according to claim 1, wherein
the torque transmission mechanism has urging means that urges a plurality of the cams to a rotating direction thereof;
in a state where the minimum radius part is opposed to the inner peripheral surface of the outer ring, a diameter including the minimum radius part is formed smaller than an interval between the outer peripheral surface of the inner ring and the inner peripheral surface of the outer ring;
the urging means has a spring extended around a pressing portion provided on the cam and urging the pressing portion to an inner ring direction; and
the pressing portion provided in the cam is formed so as to be pressed by the spring at a position eccentric to a rotation center of the cam.

4. The overload protecting device according to claim 1, wherein
at least either one of the outer peripheral surface of the inner ring and the inner peripheral surface of the outer ring is constituted movably in a radial direction and is urged to a direction approaching each other.

5. The overload protecting device according to claim 1, wherein
the cam is formed of an elastic material or includes an elastic member, and a radius of the maximum radius part is constituted changeably.
